(19) United States
(12) Patent Application Publication
(10) Pub. No.: US 2016/0277505 A1
(43) Pub. Date: Sep. 22, 2016

(54) Method and Device for Controlling Intelligent Terminal

(71) Applicant: ZTE CORPORATION, Shenzhen, Guangdong Province (CN)

(72) Inventor: Lizhu ZHANG, Shenzhen, Guangdong Province (CN)

(73) Assignee: ZTE CORPORATION, Shenzhen, Guangdong Province (CN)

(21) Appl. No.: 15/037,166

(22) PCT Filed: May 20, 2014
(86) PCT No.: PCT/CN2014/077910

§ 371 Date: May 17, 2016

(30) Foreign Application Priority Data
Nov. 18, 2013 (CN) 201310578890.X

(51) Int. Cl. H04L 29/08; H04W 88/02; H04L 29/06

(52) U.S. Cl. CPC H04L 67/125; H04L 67/42; H04W 88/02; H04L 63/08

(57) ABSTRACT

The embodiments of disclosure disclose a method and device for controlling an intelligent terminal. According to the disclosure, a server sends a to-be-controlled using manner type and corresponding parameter and/or a to-be-controlled application program type and corresponding control parameter, preset by a user of a first terminal, of a second terminal to the second terminal in communication connection with the server for the second terminal to control a current using manner according to a control parameter corresponding to the current using manner when the current using manner adopted by the user for the second terminal is of the preset to-be-controlled using manner type and/or control a current application program according to a control parameter corresponding to the current application program when the current application program used by the user in the second terminal is of the preset to-be-controlled application program type.

### TECHNICAL FIELD

The disclosure relates to the field of intelligent terminal control, and in particular to a method and device for controlling an intelligent terminal.

### BACKGROUND

In an increasing information era, intelligent terminals, such as mobile phones and tablets, in which rich application software may be installed, have been gradually developed deep into daily work, life and study of people. For example, intelligent terminals enter study and life of some inexperienced children or students who are poor in self control, and with the intelligent terminals, they may search for information that they concern about from an Internet, and may also install various favorite applications and enjoy application games; however, when enjoying convenience and happiness brought by the intelligent terminals, they usually forget about time or install and watch information which is unhealthy physically and mentally, which may bring undesirable influence on their life and study. Therefore, it is necessary to limit use over some applications on their intelligent terminals and using time periods of the applications.

At present, monitoring an intelligent terminal does not limit use of the intelligent terminal and its application program, but only monitors and acquires a using condition of the intelligent terminal, so that use of a user over the intelligent terminal may not be well controlled.

### SUMMARY

The embodiments of disclosure provide a method and device for controlling an intelligent terminal, which limit use over the intelligent terminal and application programs of the intelligent terminal so as to well achieve an effect of controlling use of a user over the intelligent terminal.

The embodiments of the disclosure disclose a method for controlling an intelligent terminal, which may include that:

Step A: when receiving a control parameter setting instruction from a user, providing, by a server, a parameter setting interface to a first terminal in communication connection with the server for the user of the first terminal to preset a to-be-controlled using manner type and corresponding control parameter, and/or, a to-be-controlled application program type and corresponding control parameter of a second terminal; and Step B: sending, by the server, the control parameter set by the first terminal on a basis of the parameter setting interface to the second terminal in communication connection with the server for the second terminal to control a current using manner according to a control parameter corresponding to the current using manner when a current using manner adopted by the user for the second terminal is of the preset to-be-controlled using manner type and/or control a current application program according to a control parameter corresponding to the current application program when the current application program used by the user in the second terminal is of the preset to-be-controlled application program type.

In an example embodiment, after Step B, the method further includes: Step B1: when a modification request for the control parameter of the current using manner of the second terminal and/or the control parameter of the current application program used in the second terminal is received from the user of the second terminal, sending, by the server, modification data corresponding to the modification request to the first terminal; and Step B2: when response information based on the modification data corresponding to the modification request is received from the first terminal, sending, by the server, the response information to the second terminal for the second terminal to control the current using manner of the second terminal and/or the current application program used in the second terminal according to the response information.

In an example embodiment, before Step A, the method further includes: Step A1: when a verification request is received from the user, providing, by the server, a verification interface for the first terminal in communication connection with the server, receiving verification information input by the user of the first terminal and analyzing whether there is preset verification information consistent with the received verification information or not; and Step A2: when there is the preset verification information consistent with the received verification information, sending, by the server, verification success information to the first terminal.

In an example embodiment, after Step A1, the method further includes: Step A3: when the preset verification information, which is consistent with the received verification information, is not existed, sending, by the server, verification failure prompting information to the first terminal to prompt the user of the first terminal to input correct verification information to acquire a right over setting of the control parameter of the second terminal.

The embodiments of the disclosure further disclose a method for controlling an intelligent terminal, which may include that:

Step C: when receiving a control parameter setting instruction from a user, providing, by the intelligent terminal, a parameter setting interface for the user to preset a to-be-controlled using manner type and corresponding control parameter, and/or, a to-be-controlled application program type and corresponding control parameter of the intelligent terminal; and Step D: when a current using manner adopted by the user for the intelligent terminal is of the preset to-be-controlled using manner type, controlling, by the intelligent terminal, the current using manner according to a control parameter corresponding to the current using manner, and/or, when a current application program used by the user in the intelligent terminal is of the preset to-be-controlled application program type, controlling, by the intelligent terminal, the current application program according to a control parameter corresponding to the current application program.

The embodiments of the disclosure further disclose a device for controlling an intelligent terminal, which may include:

a parameter setting component, configured to, when receiving a control parameter setting instruction from a user, provide a parameter setting interface to a first terminal in communication connection with the device for the user of the first terminal to preset a to-be-controlled using manner type and corresponding control parameter, and/or, a to-be-controlled application program type and corresponding control parameter of a second terminal; and a data forwarding component, configured to send the control parameter set by the first terminal on a basis of the parameter setting interface to the second terminal in communication connection with the device for the second terminal to control a current using manner according to a control parameter corresponding to the current using manner when the current using manner adopted by the user for the second terminal is of the preset to-be-controlled using manner type and/or control a current application program according to a control parameter corresponding to the current application program when the current application program used by the user in the second terminal is of the preset to-be-controlled application program type.

In an example embodiment, the parameter setting component is further configured to, when receiving a modification request for the control parameter of the current using manner of the second terminal and/or the control parameter of the current application program used in the second terminal from the user of the second terminal, send modification data corresponding to the modification request to the first terminal; and when receiving response information based on the modification data corresponding to the modification request from the first terminal, send the response information to the second terminal for the second terminal to control the current using manner of the second terminal and/or the current application program used in the second terminal according to the response information.

In an example embodiment, the device further includes: a verification component and an analysis component, wherein the verification component, which is configured to, when receiving a verification request from the user, provide a verification interface to the first terminal in communication connection with the device, and receive verification information input by the user of the first terminal; the analysis component, which is configured to analyze whether there is preset verification information consistent with the received verification information or not; and the verification component is further configured to, when there is preset verification information consistent with the received verification information, send verification success information to the first terminal.

In an example embodiment, the verification component is further configured to, when the preset verification information, which is consistent with the received verification information, is not existed, send verification failure prompting information to the first terminal to prompt the user of the first terminal to input correct verification information to acquire a right over setting of the control parameter of the second terminal.

The embodiments of the disclosure further disclose a device for controlling an intelligent terminal, which may include:

a parameter setting component, configured to, when receiving a control parameter setting instruction from a user, provide a parameter setting interface to the user to preset a to-be-controlled using manner type and corresponding control parameter and/or to-be-controlled application program type and corresponding control parameter of the intelligent terminal; and a control component, configured to, when a current using manner adopted by the user for the intelligent terminal is of the preset to-be-controlled using manner type, control the current using manner according to a control parameter corresponding to the current using manner, and/or, when a current application program used by the user in the intelligent terminal is of the preset to-be-controlled application program type, control the current application program according to a control parameter corresponding to the current application program.

Compared with the related art, the embodiment of the disclosure has the advantages that the server sends the preset to-be-controlled using manner type and corresponding parameter and/or a to-be-controlled application program type and corresponding control parameter, preset by the user of the first terminal, of the second terminal to the second terminal in communication connection with the server for the second terminal to control the current using manner according to the control parameter corresponding to the current using manner when the current using manner adopted by the user for the second terminal is of the preset to-be-controlled using manner type and/or control the current application program according to the control parameter corresponding to the current application program when the current application program used by the user in the second terminal is of the preset to-be-controlled application program type. Therefore, use over the intelligent terminal and its application program is limited, and the effect of controlling the use of the user over the intelligent terminal is well achieved.

### BRIEF DESCRIPTION OF THE DRAWINGS

FIG. 1 is a flowchart of a method for controlling an intelligent terminal according to a first embodiment of the disclosure;

FIG. 2 is a flowchart of a method for controlling an intelligent terminal according to a second embodiment of the disclosure;

FIG. 3 is a flowchart of a method for controlling an intelligent terminal according to a third embodiment of the disclosure;

FIG. 4 is a flowchart of a method for controlling an intelligent terminal according to a fourth embodiment of the disclosure;

FIG. 5 is a schematic diagram of function components in a device for controlling an intelligent terminal according to a first embodiment of the disclosure; and

FIG. 6 is a schematic diagram of function components in a device for controlling an intelligent terminal according to a second embodiment of the disclosure.

Achievement of the purpose, function characteristics and advantages of the disclosure will be further described with reference to embodiments and the drawings.

### DETAILED DESCRIPTION OF THE EMBODIMENTS

It should be understood that specific embodiments described here are only adopted to explain the disclosure and not intended to limit the disclosure.

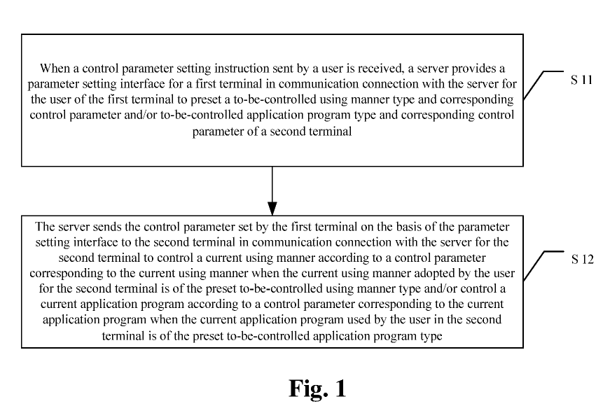

FIG. 1 is a flowchart of a method for controlling an intelligent terminal according to a first embodiment of the disclosure.

It is important to emphasize that: the flowchart shown in FIG. 1 is only an example embodiment, and those skilled in the art should know that any embodiments constructed on the basis of the concept of the disclosure shall fall within the scope of the following technical solution:

Step A: when a control parameter setting instruction sent by a user is received, a server provides a parameter setting interface to a first terminal in communication connection with the server for the user of the first terminal to preset a to-be-controlled using manner type and corresponding control parameter, and/or, a to-be-controlled application program type and corresponding control parameter of a second terminal; and Step B: the server sends the control parameter set by the first terminal on a basis of the parameter setting interface to the second terminal in communication connection with the server for the second terminal to control a current using manner according to a control parameter corresponding to the current using manner when the current using manner adopted by the user for the second terminal is of the preset to-be-controlled using manner type and/or control a current application program according to a control parameter corresponding to the current application program when the current application program used by the user in the second terminal is of the preset to-be-controlled application program type.

Intelligent terminal control is gradually implemented in the embodiment by the following steps.

Step 11: when the control parameter setting instruction sent by the user is received, the server provides the parameter setting interface for the first terminal in communication connection with the server for the user of the first terminal to preset the to-be-controlled using manner type and corresponding control parameter and/or the to-be-controlled application program type and corresponding control parameter of the second terminal.

In an example embodiment, the server provides a human-computer interaction interface for an intelligent terminal, a user of the intelligent terminal inputs login information to log in the server through the human-computer interaction interface, the user is registered as a login account of the server through the human-computer interaction interface when accessing the server for the first time, and acquires verification information corresponding to the login account, and the user of the intelligent terminal inputs the successfully registered login account and the corresponding verification information on the human-computer interaction interface to log in the server. The user of the intelligent terminal specifies identity information (including a username and a password) of a control terminal and identity information (including a username and a password) of a controlled terminal through the human-computer interaction interface, that is, the user may be verified by the server to acquire a terminal control right through the identity information of the control terminal and preset a to-be-controlled using manner type and corresponding control parameter and/or a to-be-controlled application program type and corresponding control parameter of the controlled terminal.

In the embodiment, the identity information of the control terminal is input on the first terminal through the human-computer interaction interface provided by the server for the user to pass verification of the server, and when the user of the first terminal passes verification of the server, the user of the first terminal sends the control parameter setting instruction of the second terminal to the server, the server provides the parameter setting interface for the first terminal in communication connection with the server for the user of the first terminal to preset the to-be-controlled using manner type and corresponding control parameter and the to-be-controlled application program type and corresponding control parameter of the second terminal when receiving the control parameter setting instruction sent by the user, and inputting the identity information of the control terminal for verification aims to acquire a right over setting of the control parameter; and the user of the second terminal logs in the second terminal to obtain a right over use of the second terminal through the identity information of the controlled terminal, and uses the second terminal according to the corresponding control parameter.

A process that the user of the first terminal acquires the right over setting of the control parameter includes that: the user of the first terminal sends a verification request to the server, the server provides a verification interface for the first terminal in communication connection with the server when receiving the verification request sent by the user, receives identity verification information input by the user of the first terminal and analyzes whether there is preset identity verification information consistent with the received identity verification information or not, and when there is preset identity verification information consistent with the received identity verification information, the server sends verification success information to the first terminal; and when there is no preset identity verification information consistent with the received identity verification information, the server sends verification failure prompting information to the first terminal to prompt the user of the first terminal to input correct verification information to acquire the right over setting of the control parameter of the second terminal.

Similarly, a process that the user of the second terminal acquires the right over use of the second terminal includes that: the user of the second terminal sends a verification request to the server, the server provides a verification interface for the second terminal in communication connection with the server when receiving the verification request sent by the user, receives identity verification information input by the user of the second terminal and analyzes whether there is preset identity verification information consistent with the received identity verification information or not, and when there is preset identity verification information consistent with the received identity verification information, the server sends verification success information to the second terminal, and the user of the second terminal acquires the right over use of the second terminal, and controls use of the user of the second terminal over the second terminal according to the set control parameter; and when there is no preset identity verification information consistent with the received identity verification information, the server sends verification failure prompting information to the second terminal to prompt the user of the second terminal to input correct verification information to acquire the right over use of the second terminal.

In the embodiment, the to-be-controlled using manner type of the second terminal includes, but not limited to, limited use of the second terminal, limited use of a network of the second terminal or limited connection of the second terminal with other external equipment; a control parameter corresponding to limited use of the second terminal is that the right over use of the second terminal may be acquired by identity verification, a control parameter corresponding to limited use of the network of the second terminal is that the user of the second terminal is not allowed to use the network or the user of the second terminal is only allowed to use the network for a fixed time length, and a control parameter corresponding to limited connection of the second terminal with the other external equipment is that a right over connection with the other external equipment is required to be requested to the first terminal which controls the second terminal. The to-be-controlled application program type of the second terminal includes, but not limited to, QQ, a browser or a card game; and the control parameter corresponding to the to-be-controlled application program type of the second terminal includes, but not limited to whether a to-be-controlled application program may be downloaded or run or not or a running time length of the to-be-controlled application program. For example, the to-be-controlled application program type, preset by the first terminal, of the second terminal is QQ and its corresponding control parameter is a daily running time length of 30 minutes.

Step 12: the server sends the control parameter set by the first terminal on the basis of the parameter setting interface to the second terminal in communication connection with the server for the second terminal to control the current using manner according to the control parameter corresponding to the current using manner when the current using manner adopted by the user for the second terminal is of the preset to-be-controlled using manner type and/or control the current application program according to the control parameter corresponding to the current application program when the current application program used by the user in the second terminal is of the preset to-be-controlled application program type.

In an example embodiment, the server sends the control parameter set by the first terminal on the basis of the parameter setting interface to the second terminal in communication connection with the server, and the second terminal controls use of the user over the second terminal according to the received control parameter when the user uses the second terminal after the second terminal receives the control parameter sent by the server, that is, the second terminal controls the current using manner according to the control parameter corresponding to the current using manner when the current using manner adopted by the user for the second terminal is of the preset to-be-controlled using manner type, and/or, controls the current application program according to the control parameter corresponding to the current application program when the current application program used by the user in the second terminal is of the preset to-be-controlled application program type. For example, if the current using manner of the second terminal is limited use, the user of the second terminal may acquire the right over use of the second terminal by inputting the identity verification information; and under the condition that the to-be-controlled application program type of the second terminal is QQ and the control parameter corresponding to QQ is the daily using time length of 30 minutes, if the current application program used by the user of the second terminal is QQ, the user of the second terminal is controlled to use QQ for only 30 minutes every day, and when QQ has been used for 30 minutes, QQ is closed or no response will be given to use of the user over QQ.

According to the embodiment, the server sends the preset to-be-controlled using manner type and corresponding parameter and/or to-be-controlled application program type and corresponding control parameter, preset by the user of the first terminal, of the second terminal to the second terminal in communication connection with the server for the second terminal to control the current using manner according to the control parameter corresponding to the current using manner when the current using manner adopted by the user for the second terminal is of the preset to-be-controlled using manner type and/or control the current application program according to the control parameter corresponding to the current application program when the current application program used by the user in the second terminal is of the preset to-be-controlled application program type. Therefore, use over the intelligent terminal and its application program is limited, and the effect of controlling the use of the user over the intelligent terminal is well achieved.

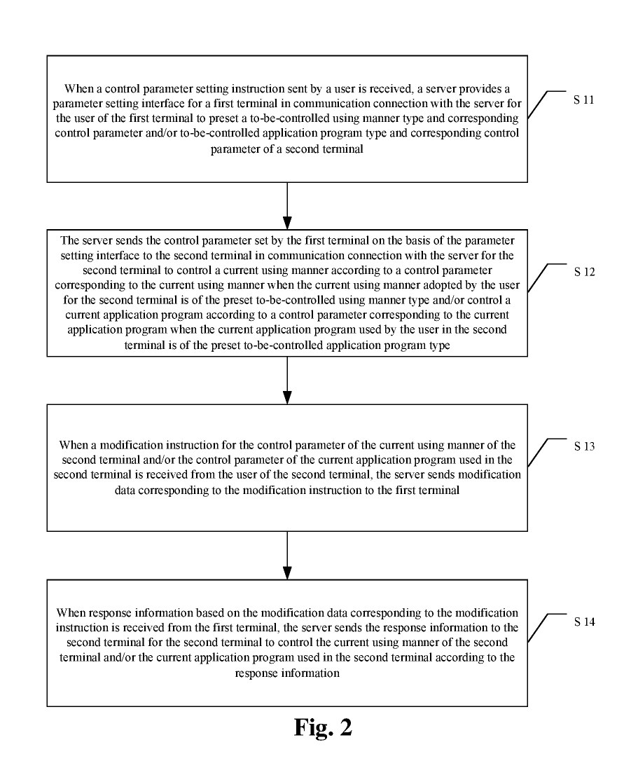

FIG. 2 is a flowchart of a method for controlling an intelligent terminal according to a second embodiment of the disclosure.

Based on the first embodiment, after Step 12, the method further includes:

Step 13: when a modification instruction for the control parameter of the current using manner of the second terminal and/or the control parameter of the current application program used in the second terminal is received from the user of the second terminal, the server sends modification data corresponding to the modification instruction to the first terminal; and

Step 14: when response information based on the modification data corresponding to the modification instruction is received from the first terminal, the server sends the response information to the second terminal for the second terminal to control the current using manner of the second terminal and/or the current application program used in the second terminal according to the response information.

In an example embodiment, the second terminal controls the current using manner according to the control parameter corresponding to the current using manner when the current using manner adopted by the user for the second terminal is of the preset to-be-controlled using manner type, and/or, controls the current application program according to the control parameter corresponding to the current application program when the current application program used by the user in the second terminal is of the preset to-be-controlled application program type. If the user of the second terminal is required to modify the current using manner and corresponding control parameter of the second terminal and/or the control parameter of the current application program used in the second terminal, the modification instruction for the control parameter(s) of the current using manner of the second terminal and/or the current application program used in the second terminal is sent to the server, the server sends the modification data corresponding to the modification instruction to the first terminal when receiving the modification instruction for the control parameter(s) of the current using manner of the second terminal and/or the current application program used in the second terminal from the user of the second terminal, and the server sends the response information to the second terminal for the second terminal to control the current using manner of the second terminal and/or the current application program used in the second terminal according to the response information when receiving the response information based on the modification data corresponding to the modification instruction from the first terminal. If the response information is accepting the modification instruction of the user of the second terminal, the second terminal modifies the control parameter of the current using manner of the second terminal and/or the control parameter of the current application program used in the second terminal, and controls the current using manner and/or the current application program according to the modified control parameter(s). For example, when the user uses QQ, the second terminal sets that the user uses QQ for 30 minutes every day according to the received set parameter of the first terminal, the user of the second terminal sends a modification request (the modification request includes modification data indicating prolonging QQ using time by 10 minutes) for the QQ using time to the server when the QQ using time reaches 25 minutes, and the server sends the modification data corresponding to the modification request to the first terminal, receives the response information based on the modification data from the first terminal, sends the response information to the second terminal for the second terminal to control the QQ using time of the second terminal according to the response information, and prolongs the QQ using time for 10 minutes if the response information is accepting the modification request of the user of the second terminal, and closes QQ or does not give any response to use of the user over QQ when the QQ using time reaches 40 minutes; if the response information is refusing the modification request of the user of the second terminal, the QQ using time is not changed, and QQ is closed or no response will be given to use of the user over QQ when the preset QQ using time of 30 minutes is reached; and if the first terminal responds to the modification request, the second terminal closes QQ or does not give any response to use of the user over QQ when the preset QQ using time of 30 minutes is reached.

In another embodiment of the disclosure, if, for example, the to-be-controlled using manner type and corresponding control parameter of the second terminal indicate a fixed time length for use of the user of the second terminal over the network and/or the to-be-controlled application program type and the corresponding control parameter indicate a fixed time length of operation of the user over a certain application program, the user is prompted that the user may not have any right over use of the network or the application program at time when preset time is left from the fixed time length, the user is prompted that whether the right over use of the network or the application program is required to be prolonged or not, and when the user determines that it is necessary to prolong the right over use of the network or the application program, the right over use of the network or the application program is prolonged by a preset time length according to the steps in the abovementioned embodiment, that is, a certain right limit is prolonged by one operation step. The preset time includes, but not limited to, 5 minutes or 2 minutes; and the preset time length includes, but not limited to, 10 minutes or 30 minutes.

According to the embodiment, the user of the second terminal sends the modification request to the server when modifying the control parameter of the current using manner of the second terminal and/or the control parameter of the current application program used in the second terminal, the server sends the modification data corresponding to the modification request to the first terminal, and sends the received response information, sent by the first terminal, based on the modification data corresponding to the modification request to the second terminal for the second terminal to control the current using manner of the second terminal and/or the current application program used in the second terminal according to the response information. Therefore, more reasonable control over the intelligent terminal is implemented.

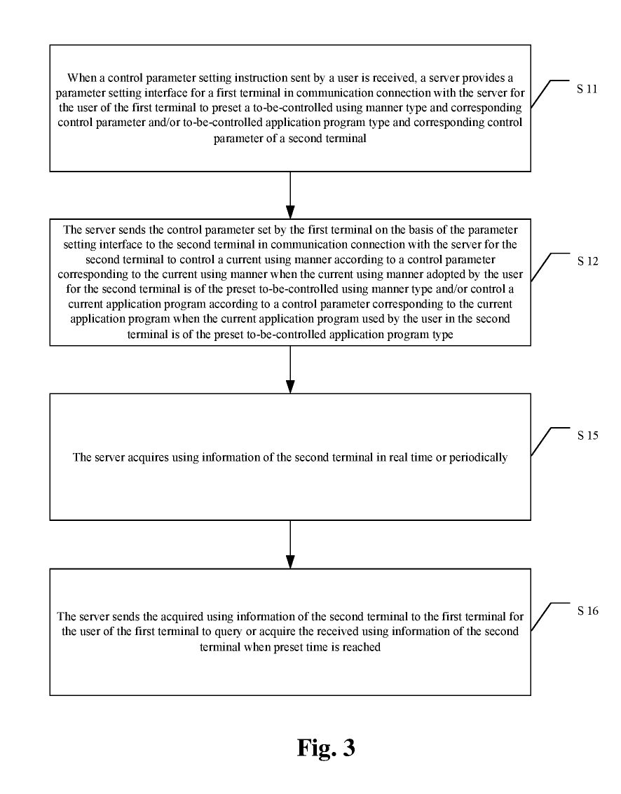

FIG. 3 is a flowchart of a method for controlling an intelligent terminal according to a third embodiment of the disclosure.

Based on the first and second embodiments, after Step 12 or Step 14, the method further includes:

Step 15: the server acquires using information of the second terminal in real time or periodically; and

Step 16: the server sends the acquired using information of the second terminal to the first terminal for the user of the first terminal to query or acquire the received using information of the second terminal when preset time is reached.

In an example embodiment, when the user uses the second terminal, the server acquires the using information of the second terminal in real time or periodically, the using information including, but not limited to, application program downloading and running of the user of the second terminal, a time length for running the application program and the like; and the server sends the acquired using information of the second terminal to the first terminal when the preset time is reached, and the user of the first terminal queries or acquires the received using information of the second terminal. The user of the first terminal correspondingly sets the control parameter of the second terminal to further control the second terminal more reasonably according to the using information of the user of the second terminal for the second terminal.

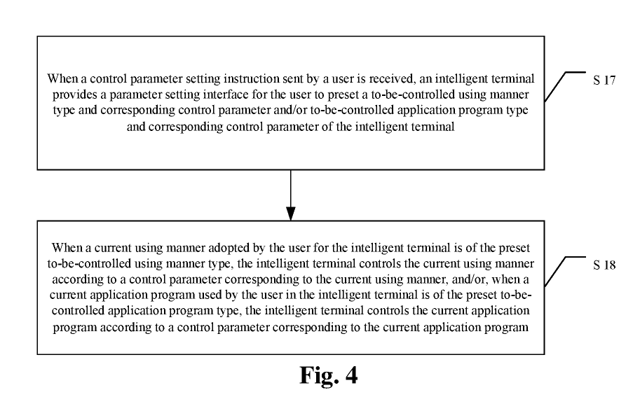

FIG. 4 is a flowchart of a method for controlling an intelligent terminal according to a fourth embodiment of the disclosure.

The difference between the embodiment and the first, second and third embodiments is that the control parameter of the intelligent terminal is locally set in the intelligent terminal, and the other steps, such as modification of the control parameter, involved in a using process of the intelligent terminal are the same as specific description in the related embodiments, and will not be elaborated herein.

As shown in FIG. 4, the method for controlling the intelligent terminal of the disclosure further includes:

Step 17: when a control parameter setting instruction sent by a user is received, an intelligent terminal provides a parameter setting interface for the user to preset a to-be-controlled using manner type and corresponding control parameter and/or to-be-controlled application program type and corresponding control parameter of the intelligent terminal; and

Step 18: when a current using manner adopted by the user for the intelligent terminal is of the preset to-be-controlled using manner type, the intelligent terminal controls the current using manner according to a control parameter corresponding to the current using manner, and/or, when a current application program used by the user in the intelligent terminal is of the preset to-be-controlled application program type, the intelligent terminal controls the current application program according to a control parameter corresponding to the current application program.

In an example embodiment, the user of the intelligent terminal may pass verification of a server through identity information of a control terminal, or does not pass verification of the server, and sends the control parameter setting instruction to the intelligent terminal, the intelligent terminal provides the parameter setting interface for the user to preset the to-be-controlled using manner type and corresponding control parameter and/or to-be-controlled application program type and corresponding control parameter of the intelligent terminal when receiving the control parameter setting instruction sent by the user, the intelligent terminal controls the current using manner according to the control parameter corresponding to the current using manner when the current using manner adopted by the user for the intelligent terminal is of the preset to-be-controlled using manner type, and/or, the intelligent terminal controls the current application program according to the control parameter corresponding to the current application program when the current application program used by the user in the intelligent terminal is of the preset to-be-controlled application program type.

According to the embodiment, the intelligent terminal provides the parameter setting interface for the user to preset the to-be-controlled using manner type and corresponding control parameter and/or to-be-controlled application program type and corresponding control parameter of the intelligent terminal; and when the current using manner adopted by the user for the intelligent terminal is of the preset to-be-controlled using manner type, the intelligent terminal controls the current using manner according to the control parameter corresponding to the current using manner; and/or, when the current application program used by the user in the intelligent terminal is of the preset to-be-controlled application program type, the intelligent terminal controls the current application program according to the control parameter corresponding to the current application program. Therefore, use over the intelligent terminal and its application program is limited, and the effect of controlling the use of the user over the intelligent terminal is well achieved.

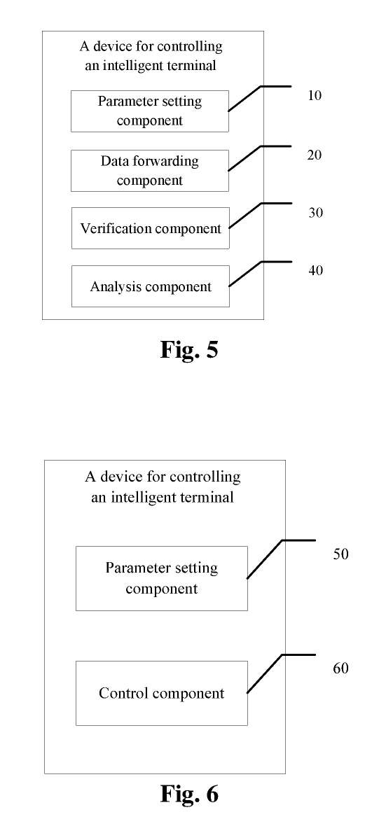

FIG. 5 is a schematic diagram of function components in a device for controlling an intelligent terminal according to a first embodiment of the disclosure. The device includes a parameter setting component 10, a data forwarding component 20, a verification component 30 and an analysis component 40.

The parameter setting component 10 is configured to, when a control parameter setting instruction sent by a user is received, provide a parameter setting interface for a first terminal in communication connection with the device for the user of the first terminal to preset a to-be-controlled using manner type and corresponding control parameter and/or to-be-controlled application program type and corresponding control parameter of a second terminal.

In an example embodiment, the device can be a server in communication connection with the first terminal and the second terminal, the server provides a human-computer interaction interface for an intelligent terminal, a user of the intelligent terminal inputs login information to log in the server through the human-computer interaction interface, the user is registered as a login account of the server through the human-computer interaction interface when accessing the server for the first time, and acquires verification information corresponding to the login account, and the user of the intelligent terminal inputs the successfully registered login account and the corresponding verification information on the human-computer interaction interface to log in the server. The user of the intelligent terminal specifies identity information (including a username and a password) of a control terminal and identity information (including a username and a password) of a controlled terminal through the human-computer interaction interface, that is, the user may be verified by the server to acquire a terminal control right through the identity information of the control terminal and preset a to-be-controlled using manner type and corresponding control parameter and/or to-be-controlled application program type and corresponding control parameter of the controlled terminal.

In the embodiment, the identity information of the control terminal is input on the first terminal through the human-computer interaction interface provided by the server for the user to pass verification of the server, and when the user of the first terminal passes verification of the server, the user of the first terminal sends the control parameter setting instruction of the second terminal to the server, the server provides the parameter setting interface for the first terminal in communication connection with the server for the user of the first terminal to preset the to-be-controlled using manner type and corresponding control parameter and the to-be-controlled application program type and corresponding control parameter of the second terminal when receiving the control parameter setting instruction sent by the user, and inputting the identity information of the control terminal for verification aims to acquire a right over setting of the control parameter; and the user of the second terminal logs in the second terminal to obtain a right over use of the second terminal through the identity information of the controlled terminal, and uses the second terminal according to the corresponding control parameter.

A process that the user of the first terminal acquires the right over setting of the control parameter includes that: the user of the first terminal sends a verification request to the server, the verification component 30 provides a verification interface for the first terminal in communication connection with the server when receiving the verification request sent by the user, and receives identity verification information input by the user of the first terminal, the analysis component 40 analyzes whether there is preset identity verification information consistent with the received identity verification information or not, and when there is preset identity verification information consistent with the received identity verification information, the verification component 30 sends verification success information to the first terminal; and when there is no preset identity verification information consistent with the received identity verification information, the verification component 30 sends verification failure prompting information to the first terminal to prompt the user of the first terminal to input correct verification information to acquire the right over setting of the control parameter of the second terminal.

Similarly, a process that the user of the second terminal acquires the right over use of the second terminal includes that: the user of the second terminal sends a verification request to the server, the verification component 30 provides a verification interface for the second terminal in communication connection with the server when receiving the verification request sent by the user, and receives identity verification information input by the user of the second terminal, the analysis component 40 analyzes whether there is preset identity verification information consistent with the received identity verification information or not, and when there is preset identity verification information consistent with the received identity verification information, the verification component 30 sends verification success information to the second terminal, and the user of the second terminal acquires the right over use of the second terminal, and controls use of the user of the second terminal over the second terminal according to the set control parameter; and when there is no preset identity verification information consistent with the received identity verification information, the verification component 30 sends verification failure prompting information to the second terminal to prompt the user of the second terminal to input correct verification information to acquire the right over use of the second terminal.

In the embodiment, the to-be-controlled using manner type of the second terminal includes, but not limited to, limited use of the second terminal, limited use of a network of the second terminal or limited connection of the second terminal with other external equipment; a control parameter corresponding to limited use of the second terminal is that the right over use of the second terminal may be acquired by identity verification, a control parameter corresponding to limited use of the network of the second terminal is that the user of the second terminal is not allowed to use the network or the user of the second terminal is only allowed to use the network for a fixed time length, and a control parameter corresponding to limited connection of the second terminal with the other external equipment is that a right over connection with the other external equipment is required to be requested to the first terminal which controls the second terminal. The to-be-controlled application program type of the second terminal includes, but not limited to, QQ, a browser or a card game; and the control parameter corresponding to the to-be-controlled application program type of the second terminal includes, but not limited to whether a to-be-controlled application program may be downloaded or run or not or a running time length of the to-be-controlled application program. For example, the to-be-controlled application program type, preset by the first terminal, of the second terminal is QQ and its corresponding control parameter is a daily running time length of 30 minutes.

The data forwarding component 20 is configured to send the control parameter set by the first terminal on the basis of the parameter setting interface to the second terminal in communication connection with the server for the second terminal to control the current using manner according to the control parameter corresponding to the current using manner when the current using manner adopted by the user for the second terminal is of the preset to-be-controlled using manner type and/or control the current application program according to the control parameter corresponding to the current application program when the current application program used by the user in the second terminal is of the preset to-be-controlled application program type.

In an example embodiment, the server sends the control parameter set by the first terminal on the basis of the parameter setting interface to the second terminal in communication connection with the server, and the second terminal controls use of the user over the second terminal according to the received control parameter when the user uses the second terminal after the second terminal receives the control parameter sent by the server, that is, the second terminal controls the current using manner according to the control parameter corresponding to the current using manner when the current using manner adopted by the user for the second terminal is of the preset to-be-controlled using manner type, and/or, controls the current application program according to the control parameter corresponding to the current application program when the current application program used by the user in the second terminal is of the preset to-be-controlled application program type. For example, if the current using manner of the second terminal is limited use, the user of the second terminal may acquire the right over use of the second terminal by inputting the identity verification information; and under the condition that the to-be-controlled application program type of the second terminal is QQ and the control parameter corresponding to QQ is the daily using time length of 30 minutes, if the current application program used by the user of the second terminal is QQ, the user of the second terminal is controlled to use QQ for only 30 minutes every day, and when QQ has been used for 30 minutes, QQ is closed or no response will be given to use of the user over QQ.

According to the embodiment, the server sends the preset to-be-controlled using manner type and corresponding parameter and/or to-be-controlled application program type and corresponding control parameter, preset by the user of the first terminal, of the second terminal to the second terminal in communication connection with the server for the second terminal to control the current using manner according to the control parameter corresponding to the current using manner when the current using manner adopted by the user for the second terminal is of the preset to-be-controlled using manner type and/or control the current application program according to the control parameter corresponding to the current application program when the current application program used by the user in the second terminal is of the preset to-be-controlled application program type. Therefore, use over the intelligent terminal and its application program is limited, and the effect of controlling the use of the user over the intelligent terminal is well achieved.

In an example embodiment, the parameter setting component 10 is configured to, when a modification request for the control parameter of the current using manner of the second terminal and/or the control parameter of the current application program used in the second terminal is received from the user of the second terminal, send modification data corresponding to the modification request to the first terminal; and

when response information based on the modification data corresponding to the modification request is received from the first terminal, send the response information to the second terminal for the second terminal to control the current using manner of the second terminal and/or the current application program used in the second terminal according to the response information.

In an example embodiment, the second terminal controls the current using manner according to the control parameter corresponding to the current using manner when the current using manner adopted by the user for the second terminal is of the preset to-be-controlled using manner type, and/or, controls the current application program according to the control parameter corresponding to the current application program when the current application program used by the user in the second terminal is of the preset to-be-controlled application program type. If the user of the second terminal is required to modify the current using manner and corresponding control parameter of the second terminal and/or the control parameter of the current application program used in the second terminal, the modification instruction for the control parameter(s) of the current using manner of the second terminal and/or the current application program used in the second terminal is sent to the server, the server sends the modification data corresponding to the modification instruction to the first terminal when receiving the modification instruction for the control parameter(s) of the current using manner of the second terminal and/or the current application program used in the second terminal from the user of the second terminal, and the server sends the response information to the second terminal for the second terminal to control the current using manner of the second terminal and/or the current application program used in the second terminal according to the response information when receiving the response information based on the modification data corresponding to the modification instruction from the first terminal. If the response information is accepting the modification instruction of the user of the second terminal, the second terminal modifies the control parameter of the current using manner of the second terminal and/or the control parameter of the current application program used in the second terminal, and controls the current using manner and/or the current application program according to the modified control parameter(s). For example, when the user uses QQ, the second terminal sets that the user uses QQ for 30 minutes every day according to the received set parameter of the first terminal, the user of the second terminal sends a modification request (the modification request includes modification data indicating prolonging QQ using time by 10 minutes) for the QQ using time to the server when the QQ using time reaches 25 minutes, and the server sends the modification data corresponding to the modification request to the first terminal, receives the response information based on the modification data from the first terminal, sends the response information to the second terminal for the second terminal to control the QQ using time of the second terminal according to the response information, and prolongs the QQ using time for 10 minutes if the response information is accepting the modification request of the user of the second terminal, and closes QQ or does not give any response to use of the user over QQ when the QQ using time reaches 40 minutes; if the response information is refusing the modification request of the user of the second terminal, the QQ using time is not changed, and QQ is closed or no response will be given to use of the user over QQ when the preset QQ using time of 30 minutes is reached; and if the first terminal responds to the modification request, the second terminal closes QQ or does not give any response to use of the user over QQ when the preset QQ using time of 30 minutes is reached.

In another embodiment of the disclosure, if, for example, the to-be-controlled using manner type and corresponding control parameter of the second terminal indicate a fixed time length for use of the user of the second terminal over the network and/or the to-be-controlled application program type and the corresponding control parameter indicate a fixed time length of operation of the user over a certain application program, the user is prompted that the user may not have any right over use of the network or the application program at time when preset time is left from the fixed time length, the user is prompted that whether the right over use of the network or the application program is required to be prolonged or not, and when the user determines that it is necessary to prolong the right over use of the network or the application program, the right over use of the network or the application program is prolonged by a preset time length according to the steps in the abovementioned embodiment, that is, a certain right limit is prolonged by one operation step. The preset time includes, but not limited to, 5 minutes or 2 minutes; and the preset time length includes, but not limited to, 10 minutes or 30 minutes.

According to the embodiment, the user of the second terminal sends the modification request to the server when modifying the control parameter of the current using manner of the second terminal and/or the control parameter of the current application program used in the second terminal, the server sends the modification data corresponding to the modification request to the first terminal, and sends the received response information, sent by the first terminal, based on the modification data corresponding to the modification request to the second terminal for the second terminal to control the current using manner of the second terminal and/or the current application program used in the second terminal according to the response information. Therefore, more reasonable control over the intelligent terminal is implemented.

In an example embodiment, the parameter setting component 10 is further configured to acquire using information of the second terminal in real time or periodically; and

the data forwarding component 20 is further configured to send the acquired using information of the second terminal to the first terminal for the user of the first terminal to query or acquire the received using information of the second terminal when preset time is reached.

In an example embodiment, when the user uses the second terminal, the server acquires the using information of the second terminal in real time or periodically, the using information including, but not limited to, application program downloading and running of the user of the second terminal, a time length for running the application program and the like; and the server sends the acquired using information of the second terminal to the first terminal when the preset time is reached, and the user of the first terminal queries or acquires the received using information of the second terminal. The user of the first terminal correspondingly sets the control parameter of the second terminal to further control the second terminal more reasonably according to the using information of the user of the second terminal for the second terminal.

As shown in FIG. 6, the disclosure further discloses a device for controlling the intelligent terminal, which includes: a parameter setting component 50 and a control component 60, wherein

the parameter setting component 50 is configured to, when a control parameter setting instruction sent by a user is received, provide a parameter setting interface for the user to preset a to-be-controlled using manner type and corresponding control parameter and/or to-be-controlled application program type and corresponding control parameter of the intelligent terminal; and

the control component 60 is configured to, when a current using manner adopted by the user for the intelligent terminal is of the preset to-be-controlled using manner type, control the current using manner according to a control parameter corresponding to the current using manner, and/or, when a current application program used by the user in the intelligent terminal is of the preset to-be-controlled application program type, control the current application program according to a control parameter corresponding to the current application program.

In an example embodiment, the user of the intelligent terminal may pass verification of a server through identity information of a control terminal, or does not pass verification of the server, and sends the control parameter setting instruction to the intelligent terminal, the intelligent terminal provides the parameter setting interface for the user to preset the to-be-controlled using manner type and corresponding control parameter and/or to-be-controlled application program type and corresponding control parameter of the intelligent terminal when receiving the control parameter setting instruction sent by the user, the intelligent terminal controls the current using manner according to the control parameter corresponding to the current using manner when the current using manner adopted by the user for the intelligent terminal is of the preset to-be-controlled using manner type, and/or, the intelligent terminal controls the current application program according to the control parameter corresponding to the current application program when the current application program used by the user in the intelligent terminal is of the preset to-be-controlled application program type.

According to the embodiment, the intelligent terminal provides the parameter setting interface for the user to preset the to-be-controlled using manner type and corresponding control parameter and/or the to-be-controlled application program type and corresponding control parameter of the intelligent terminal; and when the current using manner adopted by the user for the intelligent terminal is of the preset to-be-controlled using manner type, the intelligent terminal controls the current using manner according to the control parameter corresponding to the current using manner; and/or, when the current application program used by the user in the intelligent terminal is of the preset to-be-controlled application program type, the intelligent terminal controls the current application program according to the control parameter corresponding to the current application program. Therefore, use over the intelligent terminal and its application program is limited, and the effect of controlling the use of the user over the intelligent terminal is well achieved.

### INDUSTRIAL APPLICABILITY

According to the embodiments of the disclosure, the server sends the preset to-be-controlled using manner type and corresponding parameter and/or a to-be-controlled application program type and corresponding control parameter, preset by the user of the first terminal, of the second terminal to the second terminal in communication connection with the server for the second terminal to control the current using manner according to the control parameter corresponding to the current using manner when the current using manner adopted by the user for the second terminal is of the preset to-be-controlled using manner type and/or control the current application program according to the control parameter corresponding to the current application program when the current application program used by the user in the second terminal is of the preset to-be-controlled application program type. Therefore, use over the intelligent terminal and its application program is limited, and the effect of controlling the use of the user over the intelligent terminal is well achieved.

The above is only the example embodiment of the disclosure and thus not intended to limit the scope of the disclosure. All equivalent structure or equivalent flow transformations made by virtue of contents of the Specification and drawings of the disclosure or direct or indirect application of the contents to the other related technical fields shall also fall within the scope of protection of the disclosure.

1. A method for controlling an intelligent terminal, comprising:
Step A: when receiving a control parameter setting instruction from a user, providing, by a server, a parameter setting interface to a first terminal in communication connection with the server for the user of the first terminal to preset a to-be-controlled using manner type and corresponding control parameter, and/or, a to-be-controlled application program type and corresponding control parameter of a second terminal; and
Step B: sending, by the server, the control parameter set by the first terminal on a basis of the parameter setting interface to the second terminal in communication connection with the server for the second terminal to control a current using manner according to a control parameter corresponding to the current using manner when the current using manner adopted by the user for the second terminal is of the preset to-be-controlled using manner type and/or control a current application program according to a control parameter corresponding to the current application program when the current application program used by the user in the second terminal is of the preset to-be-controlled application program type.

2. The method as claimed in claim 1, wherein after Step B, further comprising:
Step B1: when a modification request for the control parameter of the current using manner of the second terminal and/or the control parameter of the current application program used in the second terminal is received from the user of the second terminal, sending, by the server, modification data corresponding to the modification request to the first terminal; and
Step B2: when response information based on the modification data corresponding to the modification request is received from the first terminal, sending, by the server, the response information to the second terminal for the second terminal to control the current using manner of the second terminal and/or the current application program used in the second terminal according to the response information.

3. The method as claimed in claim 1, wherein before Step A, further comprising:
Step A1: when a verification request is received from the user, providing, by the server, a verification interface for the first terminal in communication connection with the server, receiving verification information input by the user of the first terminal and analyzing whether there is preset verification information consistent with the received verification information or not; and
Step A2: when there is the preset verification information consistent with the received verification information, sending, by the server, verification success information to the first terminal.

4. The method as claimed in claim 3, wherein after Step A1, further comprising:
Step A3: when the preset verification information, which is consistent with the received verification information, is not existed, sending, by the server, verification failure prompting information to the first terminal to prompt the user of the first terminal to input correct verification information to acquire a right over setting of the control parameter of the second terminal.

5. A method for controlling an intelligent terminal, comprising:
Step C: when receiving a control parameter setting instruction from a user, providing, by the intelligent terminal, a parameter setting interface for the user to preset a to-be-controlled using manner type and corresponding control parameter, and/or, a to-be-controlled application program type and corresponding control parameter of the intelligent terminal; and
Step D: when a current using manner adopted by the user for the intelligent terminal is of the preset to-be-controlled using manner type, controlling, by the intelligent terminal, the current using manner according to a control parameter corresponding to the current using manner, and/or, when a current application program used by the user in the intelligent terminal is of the preset to-be-controlled application program type, controlling, by the intelligent terminal, the current application program according to a control parameter corresponding to the current application program.

6. A device for controlling an intelligent terminal, comprising:
a parameter setting component, configured to, when receiving a control parameter setting instruction from a user, provide a parameter setting interface to a first terminal in communication connection with the device for the user of the first terminal to preset a to-be-controlled using manner type and corresponding control parameter, and/or, a to-be-controlled application program type and corresponding control parameter of a second terminal; and
a data forwarding component, configured to send the control parameter set by the first terminal on a basis of the parameter setting interface to the second terminal in communication connection with the device for the second terminal to control a current using manner according to a control parameter corresponding to the current using manner when the current using manner adopted by the user for the second terminal is of the preset to-be-controlled using manner type and/or control a current application program according to a control parameter corresponding to the current application program when the current application program used by the user in the second terminal is of the preset to-be-controlled application program type.

7. The device as claimed in claim 6, wherein
the parameter setting component is further configured to, when receiving a modification request for the control parameter of the current using manner of the second terminal and/or the control parameter of the current application program used in the second terminal from the user of the second terminal, send modification data corresponding to the modification request to the first terminal; and
when receiving response information based on the modification data corresponding to the modification request from the first terminal, send the response information to the second terminal for the second terminal to control the current using manner of the second terminal and/or the current application program used in the second terminal according to the response information.

8. The device as claimed in claim 6, wherein further comprising: a verification component and an analysis component, wherein
the verification component, which is configured to, when receiving a verification request from the user, provide a verification interface to the first terminal in communication connection with the device, and receive verification information input by the user of the first terminal;
the analysis component, which is configured to analyze whether there is preset verification information consistent with the received verification information or not; and
the verification component is further configured to, when there is preset verification information consistent with the received verification information, send verification success information to the first terminal.

9. The device as claimed in claim 8, wherein
the verification component is further configured to, when the preset verification information, which is consistent with the received verification information, is not existed, send verification failure prompting information to the first terminal to prompt the user of the first terminal to input correct verification information to acquire a right over setting of the control parameter of the second terminal.

10. A device for controlling an intelligent terminal, comprising:
a parameter setting component, configured to, when receiving a control parameter setting instruction from a user, provide a parameter setting interface to the user to preset a to-be-controlled using manner type and corresponding control parameter and/or to-be-controlled application program type and corresponding control parameter of the intelligent terminal; and
a control component, configured to, when a current using manner adopted by the user for the intelligent terminal is of the preset to-be-controlled using manner type, control the current using manner according to a control parameter corresponding to the current using manner, and/or, when a current application program used by the user in the intelligent terminal is of the preset to-be-controlled application program type, control the current application program according to a control parameter corresponding to the current application program.

11. The method as claimed in claim 2, wherein before Step A, further comprising:
Step A1: when a verification request is received from the user, providing, by the server, a verification interface for the first terminal in communication connection with the server, receiving verification information input by the user of the first terminal and analyzing whether there is preset verification information consistent with the received verification information or not; and
Step A2: when there is the preset verification information consistent with the received verification information, sending, by the server, verification success information to the first terminal.

12. The method as claimed in claim 11, wherein after Step A1, further comprising:
Step A3: when the preset verification information, which is consistent with the received verification information, is not existed, sending, by the server, verification failure prompting information to the first terminal to prompt the user of the first terminal to input correct verification information to acquire a right over setting of the control parameter of the second terminal.
